(19) United States
(12) Patent Application Publication
(10) Pub. No.: US 2025/0203526 A1
(43) Pub. Date: Jun. 19, 2025

(54) INFORMATION PROCESSING METHOD AND APPARATUS, AND COMMUNICATION DEVICE AND STORAGE MEDIUM

(71) Applicant: Beijing Xiaomi Mobile Software Co., Ltd., Beijing (CN)

(72) Inventor: Yanhua LI, Beijing (CN)

(73) Assignee: Beijing Xiaomi Mobile Software Co., Ltd., Beijing (CN)

(21) Appl. No.: 18/847,322

(22) PCT Filed: Mar. 17, 2022
(86) PCT No.: PCT/CN2022/081506

§ 371 Date: Sep. 16, 2024

(51) Int. Cl. H04W 52/02

(52) U.S. Cl. CPC H04W 52/0274; H04W 52/0225

(57) ABSTRACT

A UE includes a first transceiver and a second transceiver. The information processing method, which is executed by the UE, includes: when a preset condition is met, controlling a UB to enter a preset mode in which a first transceiver is switched off and a second transceiver is switched on, wherein the second transceiver, which is switched on, is at least used for monitoring a preset signal.

### CROSS-REFERENCE TO RELATED APPLICATIONS

The present application is a National Stage of International Application No. PCT/CN2022/081506, filed on Mar. 17, 2022, the entire disclosure of which is incorporated herein by reference for all purposes.

### TECHNICAL FIELD

The present disclosure relates to the field of wireless communication technology but is not limited to the field of wireless communication technology, and in particular to an information processing method and apparatus, communication device and storage medium.

### BACKGROUND

In the power saving project, a power saving signal is introduced. The power saving signal may include: Downlink Control Information (DCI) for power saving (DCP) for the radio resource control (Radio Resource Control, RRC) connection state, and Paging Early Indication (PEI) for the non-connected state. DCP and PEI are both signals that can be detected by UE with extremely low power consumption.

If UE in the RRC connection state detects DCP, it means that the Physical Downlink Control Channel (PDCCH) needs to be monitored, but if no WUS is detected, the monitoring of PDCCH is skipped.

In the Discontinuous Reception (DRX) scenario of the RRC idle state, the Paging Early Indication (PEI) of the power saving signal is usually configured before the Paging Occasion (PO). If UE in the RRC idle state fail to detect the PEI, it needs to skip the monitoring of the paging DCI, otherwise it needs to monitor the paging DCI.

### SUMMARY

The embodiment of the present disclosure provides an information processing method and apparatus, a communication device and a storage medium.

The first aspect of the embodiment of the present disclosure provides an information processing method, performed by UE, wherein the UE includes: a first transceiver and a second transceiver, the method includes:
controlling the UE to enter a preset mode of turning off the first transceiver and turning on the second transceiver when a preset condition is satisfied, wherein the turned-on second transceiver is at least configured to monitor a preset signal.

The second aspect of the embodiment of the present disclosure provides an information processing method, performed by a base station, the method including:
sending indication information or condition information of a trigger condition, wherein the indication information or the condition information is configured for UE to enter a preset mode of turning off a first transceiver of the UE and turning on a second transceiver when a preset condition is satisfied, wherein the turned-on second transceiver is at least configured to monitor a preset signal by the UE.

The third aspect of the embodiment of the present disclosure provides an information processing apparatus, including:
a control module, configured to control the UE to enter a preset mode of turning off a first transceiver of the UE and turning on a second transceiver of the UE when a preset condition is satisfied, wherein the turned-on second transceiver is at least configured to monitor a preset signal.

The fourth aspect of the embodiment of the present disclosure provides an information processing apparatus, including:
a sending module, configured to send indication information or condition information of a trigger condition, wherein the indication information or the condition information is configured for UE to enter a preset mode of turning off a first transceiver of the UE and turning on a second transceiver when a preset condition is satisfied, wherein the turned-on second transceiver is at least configured to monitor a preset signal by the UE.

The fifth aspect of the embodiment of the present disclosure provides a communication device, including a processor, a transceiver, a memory, and an executable program stored in the memory and executable by the processor, wherein the processor executes the above method provided in the first aspect or the second aspect when executing the executable program.

The sixth aspect of the embodiment of the present disclosure provides a computer storage medium, having an executable program stored thereon, wherein the executable program is capable of implementing the above method provided in the first aspect or the second aspect after executed by a processor.

It should be understood that the above general description and the detailed description below are only example and explanatory, and cannot limit the embodiment of the present disclosure.

### BRIEF DESCRIPTION OF THE DRAWINGS

The drawings herein are incorporated into the specification and constitute a part of the specification, showing embodiments consistent with the present disclosure, and used to explain the principles of the embodiments of the present disclosure together with the specification.

FIG. 1 is a schematic diagram of the structure of a wireless communication system according to an example embodiment;

FIG. 2 is a flowchart of an information processing method according to an example embodiment;

FIG. 3A is a flowchart of an information processing method according to an example embodiment;

FIG. 3B is a flowchart of an information processing method according to an example embodiment;

FIG. 4 is a flowchart of an information processing method according to an example embodiment;

FIG. 5 is a flowchart of an information processing method according to an example embodiment;

FIG. 6 is a flowchart of an information processing method according to an example embodiment;

FIG. 7 is a schematic diagram of the structure of an information processing apparatus according to an example embodiment;

FIG. 8 is a schematic diagram of the structure of an information processing apparatus according to an example embodiment;

FIG. 9 is a schematic diagram of the structure of UE according to an example embodiment;

FIG. 10 is a schematic diagram of the structure of a communication device according to an example embodiment.

### DETAILED DESCRIPTION

The example embodiments will be described in detail here, and examples thereof are shown in the drawings. When the following description refers to the drawings, unless otherwise indicated, the same numbers in different drawings represent the same or similar elements. The implementations described in the following example embodiments do not represent all implementations consistent with the embodiments of the present disclosure. Instead, they are merely examples of apparatuses and methods consistent with some aspects of the embodiments of the present disclosure.

The terms used in the embodiments of the present disclosure are only for the purpose of describing specific embodiments and are not intended to limit the embodiments of the present disclosure. The singular forms “one”, “a” and “the” used in the present disclosure are also intended to include plural forms, unless the context clearly indicates other meaning. It should also be understood that the term “and/or” used herein refers to and includes any or all possible combinations of one or more associated listed items.

It should be understood that although the terms first, second, third, etc. may be used to describe various information in the embodiments of the present disclosure, the information should not be limited to these terms. These terms are only used to distinguish the same type of information from each other. For example, without departing from the scope of the embodiments of the present disclosure, the first information may also be referred to as the second information, and similarly, the second information may also be referred to as the first information. Depending on the context, the word “if” as used herein may be interpreted as “at the time of . . . ” or “when . . . ” or “in response to determining”.

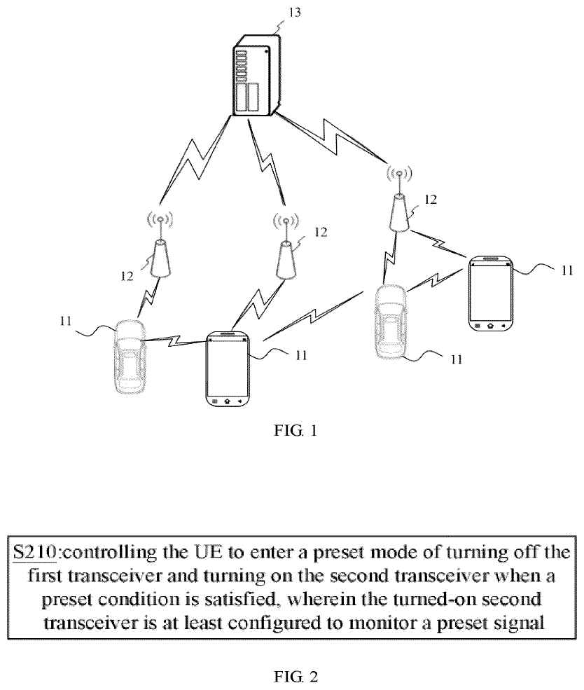

Please refer to FIG. 1, which is a schematic diagram of the structure of a wireless communication system according to an example embodiment. As shown in FIG. 1, the wireless communication system is a communication system based on cellular mobile communication technology, and the wireless communication system may include: several UE11 and several access devices 12.

The UE11 may be a device that provides voice and/or data connectivity to users. UE11 may communicate with one or more core networks via a radio access network (RAN). UE11 may be IoT UE, such as a sensor device, a mobile phone (or a “cellular” phone), and a computer with IoT UE, for example, it may be a fixed, portable, pocket-sized, handheld, computer built-in, or vehicle-mounted apparatus, for example, a station (STA), a subscriber unit, a subscriber station, a mobile station, a mobile, a remote station, an access point, a remote UE (remote terminal), an access terminal, a user terminal, a user agent, a user device, or user UE (user equipment, UE). Alternatively, UE11 may also be a device of an unmanned aerial vehicle. Alternatively. UE11 may also be a vehicle-mounted device, for example, an on-board computer with a wireless communication function, or a wireless communication device externally connected to the on-board computer. Alternatively, UE11 may also be a roadside device, for example, a street lamp, a signal lamp or other roadside devices with the wireless communication function, or the like.

The access device 12 may be a network-side device in a wireless communication system. The wireless communication system may be the 4th generation mobile communication (4G) system, also known as a Long Term Evolution (LTE) system. Alternatively, the wireless communication system may be a 5G system, also known as a new radio (NR) system or a 5G NR system. Alternatively, the wireless communication system may also be a next-generation system of the 5G system. The access network in the 5G system may be called the NG-RAN (New Generation-Radio Access Network), alternatively, an MTC system.

The access device 12 may be an evolved access device (eNB) used in the 4G system. Alternatively, the access device 12 may also be an access device (gNB) using a centralized distributed architecture in a 5G system. When the access device 12 adopts a centralized distributed architecture, it usually includes a central unit (CU) and at least two distributed units (DU). The central unit is provided with a protocol stack of a packet data convergence protocol (PDCP) layer, a radio link control (RLC) layer, and a media access control (MAC) layer. The distributed unit is provided with a physical (PHY) layer protocol stack. The specific implementation of the access device 12 is not limited in the embodiment of the present disclosure.

The wireless connection can be established between the access device 12 and the UE11 through a wireless air interface. In different implementations, the wireless air interface is a wireless air interface based on the fourth generation mobile communication network technology (4G) standard. Alternatively, the wireless air interface is a wireless air interface based on the fifth generation mobile communication network technology (5G) standard, for example, the wireless air interface is a new air interface. Alternatively, the wireless air interface can also be a wireless air interface based on the next generation mobile communication network technology standard of 5G.

As shown in FIG. 2, the embodiment of the present disclosure provides an information processing method, which is executed by UE, wherein the UE includes: a first transceiver and a second transceiver; the method includes:
S210: controlling the UE to enter a preset mode of turning off the first transceiver and turning on the second transceiver when a preset condition is satisfied, wherein the turned-on second transceiver is at least configured to monitor a preset signal.

The UE may be a terminal device of various types, including but not limited to: a mobile phone, a tablet computer, a wearable device, an IoT device, a smart home device and/or a smart office device.

In some embodiments, satisfying the preset condition includes but not limited to: when the working state of the UE and/or the network connection state of the UE satisfies the preset condition, the UE is controlled to enter a preset mode of turning off the first transceiver and turning on the second transceiver.

The UE includes a first transceiver and a second transceiver, that is, the UE has at least two transceivers. The power consumption of the first transceiver in the working state may be much greater than the power consumption required by the second transceiver in the working state, so that the preset mode may be a special power-saving working mode of the UE. It can be understood that the “preset mode” in the present disclosure refers to the mode of “turning off the first transceiver and turning on the second transceiver”.

In some embodiments, the second transceiver may be a transceiver used only for receiving the preset signal. The preset signal may be a physical layer signal sent by an access network device such as a base station. That is, the second receiver may be a transceiver that can only transceive and decode physical layer signals sent by the network device. The first transceiver can process and receive signaling and/or data of each layer sent by the network side. For example, the first transceiver can receive and decode non access stratum (NAS) messages, RRC messages, MAC layer messages and/or DCI, etc.

The preset signal may be: a signal that can trigger the UE to exit the preset mode, or inform the UE to prepare to exit the preset mode. For example, if the UE receives a preset signal through the second transceiver in the preset mode, according to the correspondence between the preset signal and the PDCCH, if the second transceiver receives specific information monitored on the PDCCH, the UE will exit the preset mode, otherwise it will maintain in the preset mode. At this time, the state in which the UE monitors the preset signal and further waits to monitor the PDCCH corresponding to the preset signal can be understood as: the state in which the UE prepares to exit the preset mode.

The UE enters a preset mode of turning on a second transceiver with low power consumption and turning off a first transceiver with high power consumption when a preset condition is satisfied. In this way, on the one hand, the power consumption of the UE can be reduced as much as possible, and on the other hand, the communication abnormality caused by the UE entering the preset mode when the preset condition is not satisfied can be reduced.

In some embodiments, S110 may include:
if the preset condition is satisfied when the UE is in a non-connected state, the UE is controlled to enter the preset mode, wherein the non-connected state includes: a RRC idle state and/or RRC inactive state.

Alternatively,

If the UE is in any state with the network device, the UE is controlled to enter the preset mode, wherein the any state includes: a RRC connection state, a RRC idle state and/or a RRC inactive state.

For example, controlling the UE to enter the preset mode if the UE is in any state with the network device may include:
if the preset condition is satisfied when the UE is in a RRC connection state with the network device and there is no data transmission with the network device currently, the UE is controlled to enter the preset mode.

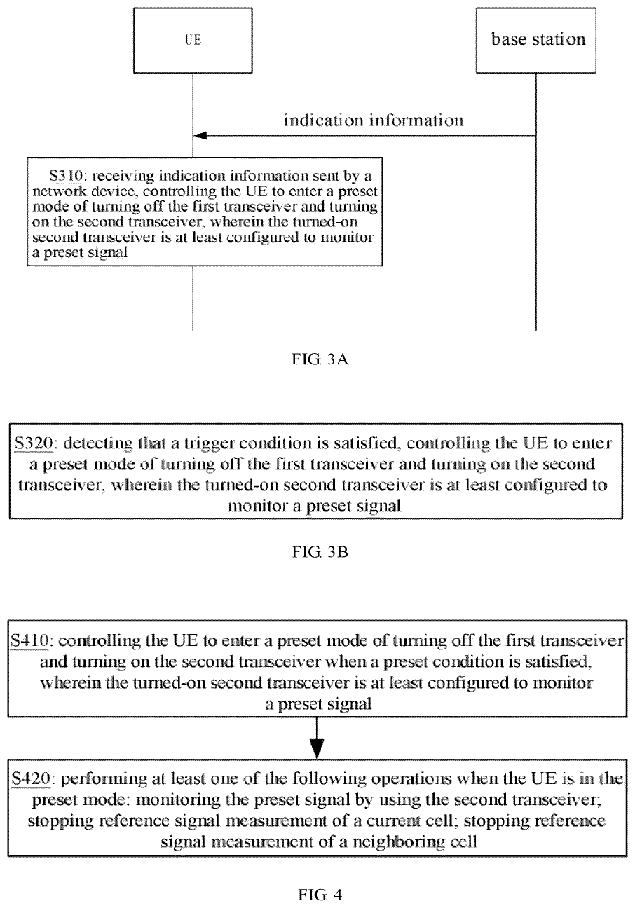

As shown in FIG. 3A, the embodiment of the present disclosure provides an information processing method, which is executed by UE, wherein the UE includes: a first transceiver and a second transceiver; the method includes:
S310: receiving indication information sent by a network device, controlling the UE to enter a preset mode of turning off the first transceiver and turning on the second transceiver, wherein the turned-on second transceiver is at least configured to monitor a preset signal.

The indication information may be sent by a network device such as a base station, and the UE receiving the indication information may be considered as that the preset condition is satisfied currently, and the UE may enter a preset mode with low power consumption. The power consumption of the UE in the preset mode is lower than that of the UE in the RRC idle state when the first transceiver is turned on.

The indication information is contained in one of following messages:
a broadcast message;
a radio link control RRC dedicated message.

For example, the broadcast message may include various system message blocks. The system message block includes but not limited to: Master Information Block (MIB) and/or System Information Block (SIB) x, where x is a positive integer.

If the RRC dedicated message can be a RRC connection release message, then when the UB receives the RRC connection release message, it will synchronously receive the indication information, to determine whether it needs to proceed to the preset mode.

For example, in some embodiments, the RRC connection release message may be a RRC dedicated message that triggers the UE to enter the RRC idle state, and after the UE receives the RRC connection release message, it will further enter the preset mode. At this time, the preset mode can be considered as the super RRC idle state of the UE, which is a state with lower power consumption than the conventional RRC idle state. The conventional RRC idle state is a state that the UE still turns on the first transceiver but releases the RRC connection with the network device.

In some embodiments, the indication information further includes at least one of the following:
duration information, configured to determine duration of the UE in the preset mode;
effective mode information, configured to determine an effective mode of the indication information.

The duration indicated by the duration information may be the duration of the UE entering the preset mode once, or the duration of the UE entering the preset mode at this time.

In some embodiments, the indication of the effective mode information indicates the effective mode of the indication information, and the effective timing of the indication information is different under different effective modes.

For example, the effective mode includes but is not limited to one of the following:
an immediate effective mode, that is, when the UE receives the indication information, the indication information takes effect immediately;
a delayed effective mode, that is, when the UE receives the indication information, it takes effect after a certain period of time;
a conditional effective mode, that is, after the UE receives the indication information, it takes effect after detecting that the effective condition is satisfied.

Therefore, in some embodiments, the effective mode indicated by the effective mode information includes at least one of the following:
an immediate effective mode, configured to take effect immediately after the UE receives the indication information;
a delayed effective mode, configured to determine effective time according to effective time information carried by the indication information;
a conditional effective mode, which is used for the UE to enter the preset mode according to the indication information after determining that the preset condition is satisfied and detecting the effective condition.

If the indication information contains the effective mode information indicating that the delayed effective mode is adopted, the effective time will be determined according to the effective time information carried by the indication information, or if the indication information carries the effective time information moment, it is considered that the current indication information adopts the delayed effective mode.

If the indication information indicates that the conditional effective mode is adopted, the indication information may include: an identifier of the effective condition; the UE can judge whether the effective condition is satisfied by itself according to the effective condition pre-configured by the base station or agreed by the protocol. The effective condition includes but is not limited to: no service data to be sent cached locally, and/or no user instruction detected within a specific time period by the UE.

The effective time information may specifically indicate the effective start moment, or the time offset between the effective start moment of the indication information and the sending moment of the indication information.

In some embodiments, the time unit indicated by the effective time information may be s, ms, or a time domain unit symbol such as a subframe, a time slot, a symbol or a micro-time slot.

Specifically, in other embodiments, the effective time information includes at least one of the following:
effective moment information, configured to indicate an effective moment;
effective reference moment information and a time offset value, configured to determine the effective moment.

In some embodiments, the condition information further includes:
duration information, indicating duration of the UE in the preset mode after the trigger condition is satisfied.

In some embodiments, when the UE determines by itself to enter the preset mode when the trigger condition is satisfied, it can adopt an immediate effective mode, and the UE will enter the preset mode immediately. If a delayed effective mode is adopted, the UE will enter the preset mode after a delay equal to the duration indicated by the duration information according to the duration indicated by the duration information contained in the condition information.

In some embodiments, the downlink transmission includes at least one of the following:
service data;
downlink control information (DCI) sent by a physical downlink control channel (PDCCH);
paging early indication.

The preset signal includes a power saving signal.

The power saving signal may be any signal involved in saving the power consumption of the UE, for example, including but not limited to: DCP and/or PEI.

In some embodiments, the power saving signal may also include: a wake-up signal for waking up the UE and/or a sleep signal for indicating that the UE is in a sleep mode, etc.

As shown in FIG. 3B, the embodiment of the present disclosure provides an information processing method, which is executed by the UE, wherein the UE includes: a first transceiver and a second transceiver; the method includes:
S320: detecting that a trigger condition is satisfied, controlling the UE to enter a preset mode of turning off the first transceiver and turning on the second transceiver, wherein the turned-on second transceiver is at least configured to monitor a preset signal.

The trigger condition is one of the aforementioned preset conditions.

For example, the UE is configured with various configuration information that satisfies the trigger condition, and the configuration information may be sent by a network device or configured by the UE with reference to a communication protocol. Therefore, the UE will detect whether to trigger the condition by itself, if the trigger condition is bit, it can be considered that the preset condition is satisfied, so as to enter the preset mode of the UE. If it is detected that the trigger condition is satisfied to enter the preset mode, the UE can make a decision locally.

In other embodiments, if the UE detects that the trigger condition is satisfied to enter the preset mode, it is determined to report the notification information of entering the preset mode to the network device when entering the preset mode, so that the network device can know that the UE has entered the preset mode.

In some embodiments, detecting that a trigger condition is satisfied, controlling the UE to enter the preset mode includes at least one of the following:
detecting that the UE satisfies a low mobility condition, controlling the UE to enter the preset mode;
detecting that the UE satisfies a good cell signal quality condition, controlling the UE to enter the preset mode;
detecting that the UE satisfies a condition of stopping reference signal measurement of a current cell and/or a neighboring cell, controlling the UE to enter the preset mode;
detecting that the UE continuously fails to receive downlink transmission in a preset duration, controlling the UE to enter the preset mode;
detecting that a number of times that the UE continuously fails to receive downlink transmission reaches a number threshold, controlling the UE to enter the preset mode.

In one embodiment, there are a plurality of trigger conditions, and the above is only a few examples, and the specific implementation is not limited to the above examples.

For example, if the UE satisfies the low mobility condition, it means that the mobility of the UE is very low. For example, if the UE remains in the current area, then when there is no service data transmission, the UE has low measurement requirements for the current cell resident currently and the neighboring cells of the current cell. At this time, the UE can be allowed to enter the preset mode, and only the second transceiver needs to be kept on, and the first transceiver can be turned off, to save the power consumption of the UE.

For example, the low mobility condition can define one or more low mobility thresholds. For example, if the UE detects that the signal quality fluctuation range of the reference signal of the current cell and/or the neighboring cell is less than the low mobility threshold, it can be considered that the low mobility condition is satisfied.

In some embodiments, relaxation measurement of the UE will also use the low mobility condition. In some cases, the low mobility threshold of the low mobility condition used to determine whether to enter the preset mode may be equal to or greater than the low mobility threshold of the low mobility condition used by relaxation measurement of the UE.

In some embodiments, the UE will detect the reference signal of the current cell and/or the neighboring cell. If the signal quality of the detected reference signal is greater than the quality threshold, it can be considered that the good cell signal quality condition is satisfied. The UE can also reduce or stop measurement of the reference signal of the current cell and/or the neighboring cell. In this way, it can also be considered that the preset condition is satisfied.

In some embodiments, it may also be configured with a measurement condition that the UE stops measuring the reference signal of the current cell and/or the neighboring cell. If the condition is satisfied, it can also be considered that the condition for the UE to enter the preset mode is satisfied.

In some embodiments, the UE has not received downlink transmission for a long time period, and the UE can also enter the preset mode.

The downlink transmission includes but is not limited to: downlink signaling and/or downlink data.

In some other embodiments, it is detected that a number of times that the UE continuously fails to receive downlink transmission reaches a number threshold, and the number threshold can be a preset value. The downlink transmission is a predetermined downlink transmission, for example, the transmission of PDCCH. In these two cases, it means that the UE has a small communication demand and can enter the preset mode.

In some embodiments, the method also includes:
receiving condition information of the trigger condition sent by the network device;
or,
determining the trigger condition according to protocol agreement.

The condition information may be carried by RRC signaling, or the trigger condition may be determined according to the protocol agreement.

In some embodiments, the condition information further includes: effective mode information for indicating the effective mode and/or duration information. The effective mode indicates that after the UE detects that the trigger condition is satisfied, it determines when to enter the preset mode according to the effective mode information. The effective mode includes but is not limited to: an immediate effective mode, a delayed effective mode and/or a conditional effective mode.

The duration information may indicate the duration of the UE entering the preset mode.

As shown in FIG. 4, the embodiment of the present disclosure provides an information processing method, which is executed by the UE, wherein the UE includes: a first transceiver and a second transceiver; the method includes:
S410; controlling the UE to enter a preset mode of turning off the first transceiver and turning on the second transceiver when a preset condition is satisfied, wherein the turned-on second transceiver is at least configured to monitor a preset signal;
S420: performing at least one of the following operations when the UE is in the preset mode:
monitoring the preset signal by using the second transceiver; stopping reference signal measurement of a current cell; stopping reference signal measurement of a neighboring cell.

In this preset mode, the power consumption of the UE can be saved as much as possible, and the preset mode is entered only when the preset condition is satisfied, which ensures smooth communication of the UE.

As shown in FIG, 5, the embodiment of the present disclosure provides an information processing method, which is executed by a base station, wherein the method includes:
S510: sending indication information or condition information of a trigger condition, wherein the indication information or the condition information is configured for UE to enter a preset mode of turning off a first transceiver of the UE and turning on a second transceiver when a preset condition is satisfied, wherein the turned-on second transceiver is at least configured to monitor a preset signal by the UE.

The indication information or condition information is used for the UE to determine whether the preset condition is satisfied, thereby entering a preset mode of saving power consumption, thereby controlling the UE to enter the preset mode at appropriate time, achieving UE power consumption saving while ensuring normal service communication and instruction transmission of the UE.

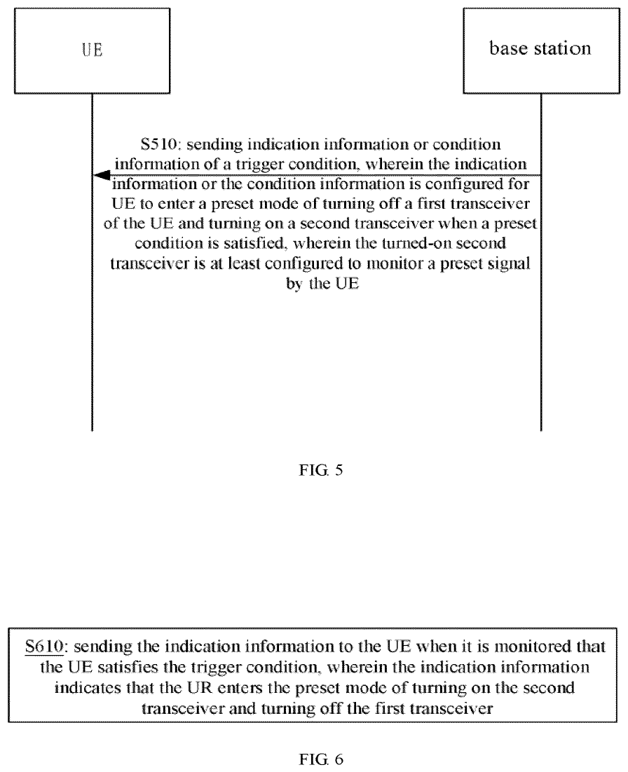

As shown in FIG. 6, the embodiment of the present disclosure provides an information processing method, which is executed by a base station, wherein the method includes:
S610: sending the indication information to the UE when it is monitored that the UE satisfies the trigger condition, wherein the indication information indicates that the UR enters the preset mode of turning on the second transceiver and turning off the first transceiver.

In some embodiments, the base station performs judgment of the trigger condition, and if the trigger condition is satisfied, the indication information is sent to the UE.

In other embodiments, the base station may not perform judgment on whether the current state of the UE satisfies the trigger condition, and the base station sends the indication information to the UE, which may include at least one of the following:
the base station receives the indication information sent by the core network device indicating that the UE enters the preset mode, sending the indication information to the UE;
after the base station receives the request information sent by the UE to request to enter the preset mode, sending the indication information to the UE;
the base station sending the indication information to the UE when it is determined that the UE can enter the preset mode according to the control strategy configured by the communication operator.

In other embodiments, the base station may also send the condition information of the trigger condition to the UE, and the LE determines whether the trigger condition is satisfied by itself, thereby determining whether to enter the preset mode by itself.

If the network device sends the condition information to the UE, and the UE determines whether to enter the preset mode by itself, the UE can send the reporting information that satisfies the trigger condition for entering the preset mode to the base station before determining to enter the preset mode, so that the base station will know that the UE will enter the preset mode.

If it is determined that the trigger condition for entering the preset mode is satisfied according to the condition information when the UE is in the RRC idle state, the base station may also fail to receive the corresponding information.

In some embodiments, the trigger condition includes at least one of the following:
a low mobility condition;
a good cell signal quality condition;
the UE continuously failing to receive downlink transmission in a preset duration;
the base station continuously failing to send downlink transmission to the UE in the preset duration;
a number of times that the UE continuously fails to receive downlink transmission reaching a number threshold;
a number of times that the base station fails to send downlink transmission to the UE reaching a number threshold.

For example, after the UE determines that any of the above conditions is satisfied, it informs the base station that the above trigger condition is satisfied. Alternatively, the base station determines by itself whether it continuously fails to send downlink transmission to the UE in a preset duration, or the number of times that the base station continuously fails to send downlink transmission to the UE reaches a number threshold, then the base station can know whether the trigger condition is satisfied based on its downlink transmission to the UE.

If the UE reports report information that satisfies the trigger condition, the base station can determine to send indication information to the UE based on the report information. If the base station determines whether the trigger condition is satisfied based on its downlink transmission to the UE, it can send the above indication information to the UE to indicate that the UE enters the preset mode when the trigger condition is satisfied.

In some embodiments, the indication information or the condition information is carried in a broadcast message or a RRC dedicated message.

For example, the broadcast message includes a system message block.

For example, the RRC dedicated message includes: a RRC connection release message.

The system message block includes but is not limited to MIB or SIBx, and x can be any positive integer.

If the RRC dedicated message can be the RRC connection release message, the base station will send the indication information synchronously when sending the RRC connection release message, so that when the UE receives the RRC connection release message, the UE will enter the preset mode when it is determined that the preset condition is satisfied in the RRC non-connected state.

For example, the indication information further includes at least one of the following:
duration information, configured to determine duration of the UE in the preset mode;
effective mode information, configured to determine an effective mode of the indication information.

The duration indicated by the duration information may be the duration of the UE entering the preset mode once, or the duration of the UE entering the preset mode at this time.

In some embodiments, the indication of the effective mode information indicates the effective mode of the indication information, and the effective timing of the indication information is different under different effective modes.

For example, the effective mode indicated by the effective mode information includes at least one of the following:
an immediate effective mode, configured to take effect immediately after the UE receives the indication information;
a delayed effective mode, configured to determine effective time according to effective time information carried by the indication information.

If the indication information contains effective mode information indicating that the delayed effective mode is adopted, the effective time will be determined according to the effective time information carried by the indication information, or if the indication information carries the effective time information, it implicitly indicates that the delayed effective mode is adopted currently.

The effective time information may specifically indicate the effective start moment, or the time offset between the effective start moment of the indication information and the sending moment of the indication information.

In some embodiments, the time unit indicated by the effective time information may be s, ms, or a time domain unit symbol such as a subframe, a time slot, a symbol or a micro-time slot.

Specifically, the effective time information includes at least one of the following:
effective moment information, configured to indicate an effective moment;
effective reference moment information and a time offset value, configured to determine the effective moment.

In some embodiments, when the UE determines by itself to enter the preset mode when the trigger condition is satisfied, an immediate effective mode can be adopted, and the UE will enter the preset mode immediately. If a delayed effective mode is adopted, the UE will take effect with delay equal to the duration indicated by the duration information according to the duration indicated by the duration information contained in the condition information.

In some embodiments, the condition information further includes:
duration information, indicating duration of the UE in the preset mode after the trigger condition is satisfied.

In some embodiments, after the condition information carrying the duration information is sent, when the UE determines by itself to enter the preset mode when the trigger condition is satisfied, it can adopt an immediate effective mode, and the UE will enter the preset mode immediately. If a delayed effective mode is adopted, the UE will take effect with delay equal to the duration indicated by the duration information according to the duration indicated by the duration information contained in the condition information.

In some embodiments, the downlink transmission includes at least one of the following:
service data;
downlink control information (DCI) sent by a physical downlink control channel (PDCCH);
paging early indication.

The preset signal includes a power saving signal.

The power saving signal includes but is not limited to: WUS and/or PEI, etc.

In some embodiments, the UB is in the preset mode, at least one of the following operations is performed:
monitoring the preset signal by using the second transceiver; stopping reference signal measurement of a current cell;
stopping reference signal measurement of a neighboring cell.

The embodiment of the present disclosure provides an information processing method, which is mainly directed to the UE of the transceiver that specifically monitors the predetermined signal.

For example, the network device configures the working mode that the non-connected UE uses a separate transceiver as follows:
the power consumption of the transceiver that monitors the preset signal separately is smaller than the power consumption of the main transceiver (main radio). The separate transceiver determines whether to wake up the main transceiver based on the monitoring of the preset signal. The main transceiver can be the aforementioned first transceiver, and the separate transceiver can be the aforementioned second transceiver.

In some embodiments, the network device sends the indication information of the RRC non-connected UE using a separate transceiver.

The indication information is used to notify the UE to put the separate transceiver in the monitoring state while turn off the main transceiver.

Furthermore, if that the UE puts a separate transceiver in a monitoring state and turns off the main transceiver is a newly introduced RRC state, the indication information sent by the network device is used to make the UE migrate to the new RRC state, which can be named as a super RRC idle state, and the new RRC state is the aforementioned preset mode.

The indication information can notify the UE to put a separate transceiver in a monitoring state and turn off the main transceiver through broadcast or dedicated signaling.

As an embodiment, the dedicated signaling is a RRC connection release message. The RRC connection release carries an indication. The indication controls the UE to enter a conventional RRC idle state or a super RRC idle state. The super RRC idle state is the state that the UE is in the aforementioned preset mode.

In the conventional RRC idle state, the first transceiver (or the main transceiver) of the UE is in a working state, that is, the main transceiver is not turned off; and the second transceiver may be in a turned-off state or a turned-on state. When the UE is in the super RRC idle state, the first transceiver of the UE is turned off and the second transceiver is turned on.

As an embodiment, the dedicated signaling is a RRC connection release message. The connection release carries indication information, indicating that after receiving the indication information, the UE enters the super RRC idle state (RRC-Ultra-idle).

The effective time of the indication information for the UE can be one of the following:
taking effect immediately after the UE receives the indication information;
taking effect at a predetermined time point after the UE receives the indication information;
the indication information can be sent to the UE through broadcast signaling or dedicated signaling.

In some embodiments, the RRC dedicated signaling can also carry the duration information of the UE putting the separate transceiver in the monitoring state while turning off the main transceiver; that is, informing the UE of the duration of entering the preset mode.

Alternatively, the network device configures the trigger condition of the indication message that the RRC non-connected UE uses a separate transceiver, and sends the condition information to the UE. The condition information of the trigger condition is used to trigger the UE to put the separate transceiver in the monitoring state while turn off the main transceiver when it is determined that the trigger condition is satisfied; that is, the UE performs the operation when it is determined that the trigger condition is satisfied.

The network device may send a trigger condition for the UE to stop measurement of the current cell and the neighboring cell. The UE will put the separate transceiver is in a monitoring state while turn off the main transceiver when it is determined that the trigger condition is satisfied.

As an embodiment, the network device sends a threshold of a good cell signal quality condition and/or a low mobility condition to the UE; for example, when the UE detects that the good signal quality principle and the low mobility principle configured by the base station are satisfied, the main transceiver is turned off.

The threshold value of the good cell signal quality condition may be higher than the threshold of the good cell signal quality condition used for measurement relaxation of the neighboring cell.

In some embodiments, the network device may send a trigger condition for no downlink data. When the UE detects that the trigger condition is satisfied, the separate transceiver will be put in a monitoring state and the main transceiver will be turned off.

In one embodiment, the number of times that the network device sends a blind detection PDCCH or PEI exceeds a certain threshold; or, if no downlink transmission is detected for N consecutive DRX cycles within a period of time, it is considered that the trigger condition is satisfied, and the UE will put the separate transceiver in a monitoring state and turn off the main transceiver. Here, N may be any positive integer, for example, N is a positive integer greater than or equal to 2.

In some embodiments, if that the UE puts a separate transceiver in a monitoring state while turning off the main transceiver is a newly introduced RRC state, the trigger condition sent by the network device is used for the UE to migrate to the new RRC state. The new RRC state is the aforementioned state that the UE is in the aforementioned preset mode.

The condition information of the trigger condition can be notified to the UE by broadcast signaling or dedicated signaling.

As an embodiment, the dedicated signaling carries the condition information of the trigger condition, which is equivalent to using the RRC connection release message to notify the UE how to enter a new RRC state after entering the RRC non-connected state.

As an embodiment, the condition information of the trigger condition is sent by broadcast signaling, and the condition information is configured in the original SIB or in a new SIB. The new SIB can be a SIB that specifically carries the condition information.

As an implementation, the condition information of the trigger condition can also carry the duration information of the UE putting the separate transceiver in a monitoring state while turning off the main transceiver. If the UE detects that the trigger condition is satisfied and enters the preset mode, the moment when the UE exits the preset mode will be controlled according to the duration information.

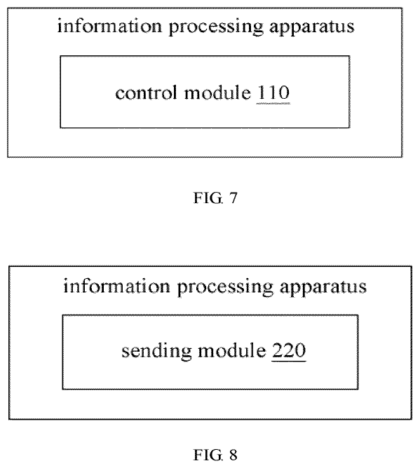

As shown in FIG. 7, an embodiment of the present disclosure provides an information processing apparatus, wherein the apparatus includes:
a control module 110, configured to control the UE to enter a preset mode of turning off a first transceiver of the UE and turning on a second transceiver of the UE when a preset condition is satisfied, wherein the turned-on second transceiver is at least configured to monitor a preset signal.

The information processing apparatus may be included in the UE.

In some embodiments, the apparatus may also include a storage module, for storing an instruction for controlling the UE to enter a preset mode, and the instruction may be generated when the UE determines that the preset condition is satisfied.

In some embodiments, the control module 110 may be a program module. After executed by the processor, the program module can control the UE to enter a preset mode of turning on the second transceiver and turning off the first transceiver realize when the preset condition is satisfied, so as to save the power consumption of the UE at appropriate time.

In other embodiments, the control module 110 may be a soft-hard combination module, which includes but is not limited to: various programmable arrays. The programmable arrays include but are not limited to: field programmable arrays and/or complex programmable arrays.

In some other embodiments, the control module 110 may be a pure hardware module. The pure hardware module includes but is not limited to a dedicated integrated circuit.

In some embodiments, the control module 110 performs one of the following:
receiving indication information sent by a network device, controlling the UE to enter the preset mode;
detecting that a trigger condition is satisfied, controlling the UE to enter the preset mode.

In some other embodiments, the control module 110 is configured to perform at least one of the following:
detecting that the UE satisfies a low mobility condition, controlling the UE to enter the preset mode;
detecting that the UE satisfies a good cell signal quality condition, controlling the UE to enter the preset mode;
detecting that the UE satisfies a condition of stopping reference signal measurement of a current cell and/or a neighboring cell, controlling the UE to enter the preset mode;
detecting that the UE continuously fails to receive downlink transmission in a preset duration, controlling the UE to enter the preset mode;
detecting that a number of times that the UE continuously fails to receive downlink transmission reaches a number threshold, controlling the UE to enter the preset mode.

In some embodiments, the apparatus further includes:
a first receiving module, configured to receive condition information of the trigger condition sent by the network device;
or,
a first determination module, configured to determine the trigger condition according to protocol agreement.

In some embodiments, the indication information is contained in one of following messages:
a broadcast message;
a radio link control RRC dedicated message.

In some embodiments, the broadcast message includes: a system message block.

In some embodiments, the RRC dedicated message includes: a RRC connection release message.

In some embodiments, the indication information further includes at least one of the following:
duration information, configured to determine duration of the UE in the preset mode;
effective mode information, configured to determine an effective mode of the indication information.

In some embodiments, the effective mode indicated by the effective mode information includes at least one of the following:
an immediate effective mode, configured to take effect immediately after the UE receives the indication information;
a delayed effective mode, configured to determine effective time according to effective time information carried by the indication information.

In some embodiments, the effective time information includes at least one of the following:
effective moment information, configured to indicate an effective moment;
effective reference moment information and a time offset value, configured to determine the effective moment.

In some embodiments, the condition information further includes:
duration information, indicating duration of the UE in the preset mode after the trigger condition is satisfied.

In some embodiments, the downlink transmission includes at least one of the following:
service data;
downlink control information (DCI) sent by a physical downlink control channel (PDCCH);
paging early indication.

In some embodiments, the preset signal includes at least one of the following:
a power saving signal.

In some embodiments, the UE is in the preset mode and performs at least one of the following operations:
monitoring the preset signal by using the second transceiver;
stopping reference signal measurement of a current cell;
stopping reference signal measurement of a neighboring cell.

As shown in FIG. 8, an embodiment of the present disclosure provides an information processing apparatus, wherein the apparatus includes:
a sending module 220, configured to send indication information or condition information of a trigger condition, wherein the indication information or the condition information is configured for UE to enter a preset mode of turning off a first transceiver of the UE and turning on a second transceiver when a preset condition is satisfied, wherein the turned-on second transceiver is at least configured to monitor a preset signal by the UE.

The information processing apparatus may be included in a base station. The base station may be an access network device such as an eNB or a gNB.

In some embodiments, the apparatus may also include a storage module, for storing indication information and/or condition information to be sent to the UE. In some embodiments, the sending module 220 may be a program module. After executed by the processor, the program module can realize the sending of the aforementioned indication information or condition information.

In other embodiments, the sending module 220 may be a soft-hard combination module, which includes but is not limited to: various programmable arrays. The programmable arrays include but are not limited to: field programmable arrays and/or complex programmable arrays.

In some other embodiments, the sending module 220 may be a pure hardware module. The pure hardware module includes but is not limited to a dedicated integrated circuit.

In some embodiments, the apparatus further includes:
a second determination module, configured to send the indication information to the UE when it is monitored that the UE satisfies the trigger condition.

In some embodiments, the trigger condition includes at least one of the following:
a low mobility condition;
a good cell signal quality condition;
the UE continuously failing to receive downlink transmission in a preset duration;
the base station continuously failing to send downlink transmission to the UE in the preset duration;
a number of times that the UE continuously fails to receive downlink transmission reaching a number threshold;
a number of times that the base station fails to send downlink transmission to the UE reaching a number threshold.

In some embodiments, the indication information or the condition information is carried in a broadcast message or a RRC dedicated message.

In some embodiments, the broadcast message includes a system message block.

In some embodiments, the RRC dedicated message includes: a RRC connection release message.

In some embodiments, the indication information further includes at least one of the following:
duration information, configured to determine duration of the UE in the preset mode;
effective mode information, configured to determine an effective mode of the indication information.

In some embodiments, the effective mode indicated by the effective mode information includes at least one of the following:
an immediate effective mode, configured to take effect immediately after the UE receives the indication information;
a delayed effective mode, configured to determine effective time according to effective time information carried by the indication information.

In some embodiments, the effective time information includes at least one of the following:
effective moment information, configured to indicate an effective moment;
effective reference moment information and a time offset value, configured to determine the effective moment.

In some embodiments, the condition information further includes:
duration information, indicating duration of the UE in the preset mode after the trigger condition is satisfied.

In some embodiments, wherein the downlink transmission includes at least one of the following:
service data;
downlink control information (DCI) sent by a physical downlink control channel (PDCCH)
paging early indication.

In some embodiments, the preset signal includes:
a power saving signal.

In some embodiments, the apparatus further includes:
an execution module, configured to perform at least one of the following operations when the UE is in the preset mode:
monitoring the preset signal by using the second transceiver; stopping reference signal measurement of a current cell;
stopping reference signal measurement of a neighboring cell.

The embodiment of the present disclosure provides a communication device, including:
a memory for storing processor executable instructions;
processors, respectively connected to the memory;
wherein the processor is configured to execute the information processing method provided by any of the aforementioned technical solutions.

The processor may include various types of storage media, which are non-transitory computer storage media, and can continue to memorize the information stored thereon after the communication device is powered down.

Here, the communication device includes: UE or a network element, and the network element may be any one of the aforementioned first network element to fourth network element.

The processor may be connected to the memory through a bus, etc., for reading an executable program stored on the memory, for example, at least one of the methods shown in FIGS. 2 to 6.

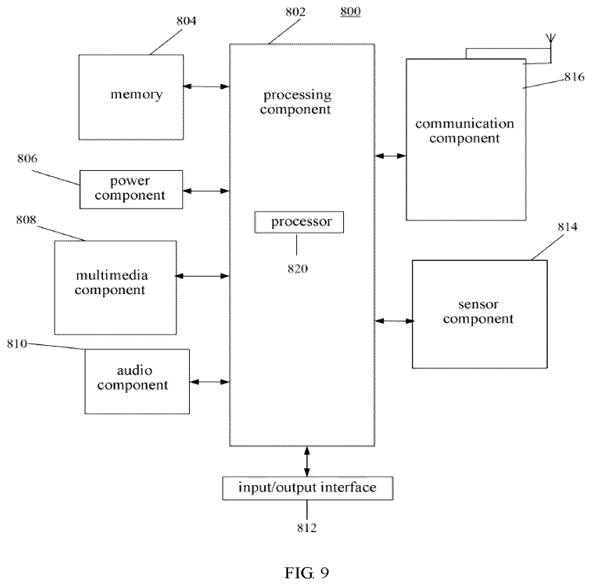

FIG. 9 is a block diagram of UE 800 according to an example embodiment. For example, the UE 800 may be a mobile phone, a computer, a digital broadcast device, a messaging device, a game console, a tablet device, a medical device, a fitness device, a personal digital assistant, or the like.

Referring to FIG. 9, the UE 800 may include one or more of the following components: a processing component 802, a memory 804, a power component 806, a multimedia component 808, an audio component 810, an input/output (I/O)) interface 812, a sensor component 814, and a communication component 816.

The processing component 802 typically controls the overall operations of the UE 800, such as the operations associated with display, telephone calls, data communications, camera operations, and recording operations. The processing component 802 can include one or more processors 820 to execute instructions to perform all or part of the steps in the above described methods. Moreover, the processing component 802 can include one or more modules to facilitate the interaction between the processing component 802 and other components. For example, the processing component 802 can include a multimedia module to facilitate the interaction between the multimedia component 808 and the processing component 802.

The memory 804 is configured to store various types of data to support the operation of the UE 800. Examples of such data include instructions for any application or method operated on the UE 800, such as the contact data, the phone book data, messages, pictures, videos, and the like. The memory 804 can be implemented by any type of volatile or non-volatile storage device, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the UE 800. The power component 806 can include a power management system, one or more power sources, and other components associated with the generation, management, and distribution of power in the UE 800.

The multimedia component 808 includes a screen providing an output interface between the UE 800 and the user. In some embodiments, the screen can include a liquid crystal display (LCD) and a touch panel (TP). If the screen includes the touch panel, the screen can be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 808 includes a front camera and/or a rear camera. When the UE 800 is in an operation mode, such as a photographing mode or a video mode, the front camera and/or the rear camera can receive external multimedia data. Each of the front camera and the rear camera may be a fixed optical lens system or have focus and optical zoom capability.

The audio component 810 is configured to output and/or input an audio signal. For example, the audio component 810 includes a microphone (MIC) configured to receive an external audio signal when the UE 800 is in an operation mode, such as a call mode, a recording mode, and a voice recognition mode. The received audio signal may be further stored in the memory 804 or sent via the communication component 816. In some embodiments, the audio component 810 also includes a speaker for outputting the audio signal.

The I/O interface 812 provides an interface between the processing component 802 and peripheral interface modules, such as a keyboard, a click wheel, buttons, and the like. These buttons may include, but not limited to, a home button, a volume button, a starting button, and a locking button.

The sensor component 814 includes one or more sensors for providing state assessments of various aspects of the UE 800. For example, the sensor component 814 can detect an open/closed state of the UE 800, relative positioning of components, such as the display and the keypad of the UE 800. The sensor component 814 can also detect a change in position of one component of the UE 800 or the UE 800, the presence or absence of user contact with the UE 800, an orientation, or an acceleration/deceleration of the UE 800, and a change in temperature of the UE 800. The sensor component 814 can also include a proximity sensor configured to detect the presence of nearby objects without any physical contact. The sensor component 814 can also include a light sensor, such as a CMOS or CCD image sensor, configured to use in imaging applications. In some embodiments, the sensor component 814 can also include an accelerometer sensor, a gyroscope sensor, a magnetic sensor, a pressure sensor, or a temperature sensor.

The communication component 816 is configured to facilitate wired or wireless communication between the UE 800 and other devices. The UE 800 can access a wireless network based on a communication standard, such as WiFi, 2G, 3G, or a combination thereof. In an example embodiment, the communication component 816 receives broadcast signals or broadcast associated information from an external broadcast management system via a broadcast channel. In an example embodiment, the communication component 816 also includes a near field communication (NFC) module to facilitate short-range communications. For example, the NFC module can be implemented based on radio frequency identification (RFID) technology, infrared data association (IrDA) technology, ultra-wideband (UWB) technology, Bluetooth (BT) technology and other technologies.

In an example embodiment, the UE 800 may be implemented with one or more application specific integrated circuits (ASICs), digital signal processors (DSPs), digital signal processing devices (DSPDs), programmable logic devices (PLDs), field programmable Gate arrays (FPGAs), controllers, microcontrollers, microprocessors or other electronic components, to perform the above methods.

In an example embodiment, a non-transitory computer-readable storage medium including instructions is further provided, such as a memory 804 including instructions, which can be executed by a processor 820 of the UE 800 to generate any of the above information processing methods performed by the UE and/or the base station. For example, the non-transitory computer-readable storage medium can be a ROM, a random access memory (RAM), a CD-ROM, a tape, a floppy disk, an optical data storage device, etc.

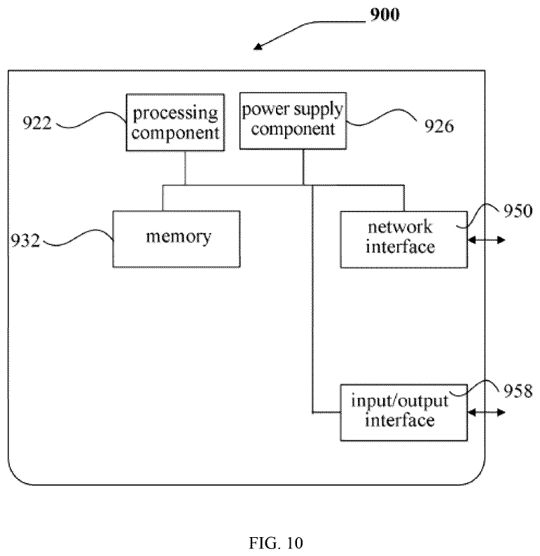

As shown in FIG. 10, an embodiment of the present disclosure shows a structure of an access device. For example, the communication device 900 may be provided as a network side device. The communication device may be the aforementioned base station.

Referring to FIG. 10, the communication device 900 includes a processing component 922, which further includes one or more processors, and a memory resource represented by a memory 932, for storing instructions executable by the processing component 922, such as an application. The application stored in the memory 932 may include one or more modules each corresponding to a set of instructions. In addition, the processing component 922 is configured to execute instructions, to execute any information processing method of the aforementioned method applied to the base station, for example, any method as shown in FIG. 2 to FIG. 6.

The communication device 900 may also include a power supply component 926 configured to perform power management of the communication device 900, a wired or wireless network interface 950 configured to connect the communication device 900 to a network, and an input/output (I/O)) interface 958. The communication device 900 can operate based on an operating system stored in the memory 932, such as Windows Server™, Mac OS X™, Unix™, Linux™, FreeBSD™ or the like.

Other implementations of the present disclosure will be apparent to those skilled in the art from consideration of the specification and practice of the present disclosure disclosed herein. The present application is intended to cover any variation, use, or adaptation of the present disclosure, which are in accordance with the general principles of the present disclosure and include common general knowledge or conventional technical means in the art that are not disclosed in the present disclosure. The specification and embodiments are exemplary only, and the real scope and spirit of the present disclosure is defined by the appended claims.

It should be understood that the present disclosure is not limited to the precise structures that have been described above and shown in the drawings, and various modifications and changes can be made without departing from the scope thereof. The scope of the present disclosure is limited only by the appended claims.

1. An information processing method, performed by UE, wherein the UE comprises; a first transceiver and a second transceiver, the method comprises:
controlling the UE to enter a preset mode of turning off the first transceiver and turning on the second transceiver in response to determining that a preset condition is satisfied, wherein the turned-on second transceiver is at least configured to monitor a preset signal.

2. The information processing method according to claim 1, wherein controlling the UE to enter a preset mode of turning off the first transceiver and turning on the second transceiver in response to determining that a preset condition is satisfied comprises one of:
receiving indication information sent by a network device, controlling the UE to enter the preset mode; or
detecting that a trigger condition is satisfied, controlling the UE to enter the preset mode.

3. The information processing method according to claim 2, wherein detecting that a trigger condition is satisfied, controlling the UE to enter the preset mode comprises at least one of:
detecting that the UE satisfies a low mobility condition, controlling the UE to enter the preset mode;
detecting that the UE satisfies a good cell signal quality condition, controlling the UE to enter the preset mode;
detecting that the UE satisfies a condition of stopping reference signal measurement of at least one of a current cell or a neighboring cell, controlling the UE to enter the preset mode;
detecting that the UE fails to receive downlink transmission in a preset duration, controlling the UE to enter the preset mode; or
detecting that a number of times that the UE fails to receive downlink transmission reaches a number threshold, controlling the UE to enter the preset mode.

4. The information processing method according to claim 3, further comprising:
receiving condition information of the trigger condition sent by the network device; or
determining the trigger condition according to protocol agreement.

5. The information processing method according to claim 2, wherein the indication information is contained in one of following messages:
a broadcast message; or
a radio link control RRC dedicated-message.

6. The information processing method according to claim 5, wherein the broadcast message comprises: a system message block.

7. The information processing method according to claim 5, wherein the RRC message comprises a RRC connection release message.

8. The information processing method according to claim 2, wherein the indication information further comprises at least one of:
duration information, configured to determine duration of the UE in the preset mode; or
effective mode information, configured to determine an effective mode of the indication information.

9. The information processing method according to claim 8, wherein the effective mode indicated by the effective mode information comprises at least one of:
an immediate effective mode, configured to take effect immediately after the UE receives the indication information; or
a delayed effective mode, configured to determine effective time according to effective time information carried by the indication information.

10. The information processing method according to claim 9, wherein the effective time information comprises at least one of:
effective moment information, configured to indicate an effective moment; or
effective reference moment information and a time offset value, configured to determine the effective moment.

11. The information processing method according to claim 4, wherein the condition information further comprises:
duration information, indicating duration of the UE in the preset mode after the trigger condition is satisfied.

12. The information processing method according to claim 3, wherein the downlink transmission comprises at least one of:
service data;
downlink control information (DCI) sent by a physical downlink control channel (PDCCH); of
paging early indication.

13. The information processing method according to claim 1, wherein the preset signal comprises: a power saving signal.

14. The information processing method according to claim 1, further comprising:
performing at least one of following operations when the UE is in the preset mode:
monitoring the preset signal by using the second transceiver;
stopping reference signal measurement of a current cell; and
stopping reference signal measurement of a neighboring cell.

15. An information processing method, performed by a network device, the method comprising:
sending indication information or condition information of a trigger condition, wherein the indication information or the condition information is configured for UE to enter a preset mode of turning off a first transceiver of the UE and turning on a second transceiver in response to determining that a preset condition is satisfied, wherein the turned-on second transceiver is at least configured to monitor a preset signal by the UE.

16. The information processing method according to claim 15, further comprising:
sending the indication information to the UE in response to determining that it is monitored that the UE satisfies the trigger condition.

17. The information processing method according to claim 15, wherein the trigger condition comprises at least one of:
a low mobility condition;
a good cell signal quality condition;
the UE failing to receive downlink transmission in a preset duration;
a base station failing to send downlink transmission to the UE in the preset duration;
a number of times that the UE fails to receive downlink transmission reaching a number threshold; or
a number of times that the base station fails to send downlink transmission to the UE reaching a number threshold.

18. The information processing method according to claim 15, wherein the indication information or the condition information is carried in a broadcast message or a RRC message.

19. The information processing method according to claim 18, wherein the broadcast message comprises a system message block.

20. The information processing method according to claim 18, wherein the RRC message comprises: a RRC connection release message.

21. The information processing method according to claim 15, wherein the indication information further comprises at least one of:
duration information, configured to determine duration of the UE in the preset mode; or
effective mode information, configured to determine an effective mode of the indication information.

22. The information processing method according to claim 21, wherein the effective mode indicated by the effective mode information comprises at least one of:
an immediate effective mode, configured to take effect immediately after the UE receives the indication information; or
a delayed effective mode, configured to determine effective time according to effective time information carried by the indication information.

23. The information processing method according to claim 22, wherein the effective time information comprises at least one of:
effective moment information, configured to indicate an effective moment; or
effective reference moment information and a time offset value, configured to determine the effective moment.

24. The information processing method according to claim 15, wherein the condition information further comprises:
duration information, indicating duration of the UE in the preset mode after the trigger condition is satisfied.

25. The information processing method according to claim 17, wherein the downlink transmission comprises at least one of:
service data;
downlink control information (DCI) sent by a physical downlink control channel (PDCCH); or
paging early indication.

26. The information processing method according to claim 15, wherein the preset signal comprises: a power saving signal.

27. The information processing method according to claim 15, wherein at least one of following operations is performed when the UE is in the preset mode:
monitoring the preset signal by using the second transceiver, stopping reference signal measurement of a current cell; or
stopping reference signal measurement of a neighboring cell.

28. An information processing apparatus, comprising:
a processor; and
a memory storing instructions executable by the processor,
wherein the processor is configured to:
control the UE to enter a preset mode of turning off a first transceiver of the UE and turning on a second transceiver of the UE in response to determining that a preset condition is satisfied, wherein the turned-on second transceiver is at least configured to monitor a preset signal.

29-41. (canceled)

42. An information processing apparatus, comprising:
a processor; and
a memory storing instructions executable by the processor,
wherein the processor is configured to execute the instructions to perform the information processing method according to claim 15.

43-56. (canceled)
